(19) United States
(12) Patent Application Publication
(10) Pub. No.: US 2024/0038964 A1
(43) Pub. Date: Feb. 1, 2024

(54) BATTERY

(71) Applicant: ZHUHAI COSMX POWER BATTERY CO., LTD., Zhuhai (CN)

(72) Inventors: Peng WU, Zhuhai (CN); Suli LI, Zhuhai (CN)

(73) Assignee: ZHUHAI COSMX POWER BATTERY CO., LTD., Zhuhai (CN)

(21) Appl. No.: 18/360,503

(22) Filed: Jul. 27, 2023

(30) Foreign Application Priority Data
Jul. 28, 2022 (CN) 202210901700.2

(51) Int. Cl. H01M 4/131; H01M 10/0525; G01N 27/02; H01M 10/0567

(52) U.S. Cl. CPC H01M 4/131; H01M 10/0525; G01N 27/026; H01M 10/0567; H01M 2004/021

(57) ABSTRACT

Disclosed is a battery, and in an electrochemical impedance spectroscopy (EIS) test of the battery, a charge transfer impedance Rct of the second semicircle in an intermediate frequency region meets: Rct<15 mΩ; and a slope k of a ray in a low frequency region meets: 1.03<k<57.29. The battery has low charge transfer impedance and lithium ion diffusion resistance during charging and discharging. The battery also has good lithium ion conductivity performance on the premise of having good cycling performance, and is a battery having good cycling performance and improved capacity, as well as good C-rate performance.

### CROSS-REFERENCE TO RELATED APPLICATIONS

The present application claims priority to Chinese Patent Application No. 202210901700.2, filed on Jul. 28, 2022, which is hereby incorporated by reference in its entirety.

### TECHNICAL FIELD

The present disclosure belongs to the field of battery technologies, and specifically, relates to a battery.

### BACKGROUND

Improving capacity and C-rate performance of a battery to meet ever expanding requirements for the battery is one of the major development trends. A single crystal material in a positive electrode material for a lithium-ion battery currently available in the market is used as an example. The single crystal material has features of good cycling performance, high compacted density, good high-voltage resistant performance, and the like, and is widely used in a pouch lithium-ion battery. However, the single crystal material also has disadvantages of relatively low capacity per gram and poor C-rate performance. Development of a battery having good cycling performance and improved capacity, as well as good C-rate performance has a better application prospect.

### SUMMARY

To overcome the disadvantages in the conventional technologies, the objective of the present disclosure is to provide a battery, and the battery has good cycling performance and improved capacity, as well as good C-rate performance. It is found through research that, when the battery has a relatively low charge transfer impedance and lithium ion diffusion resistance during charging and discharging, the battery also has good lithium ion conductivity performance on the premise of having good cycling performance, thereby obtaining a battery having good cycling performance and improved capacity, as well as good C-rate performance.

The objective of the present disclosure is implemented by using the technical solutions as follows.

A battery is provided, and in an electrochemical impedance spectroscopy (EIS) test of the battery, a charge transfer impedance Rct of the second semicircle in an intermediate frequency region meets: Rct<15 mΩ; and a slope k of a ray in a low frequency region meets: 1.03<k<57.29.

According to an implementation of the present disclosure, a frequency of the intermediate frequency region ranges from 150 Hz to 500 Hz.

According to an implementation of the present disclosure, a frequency of the low frequency region ranges from 0.01 Hz to 150 Hz.

According to an implementation of the present disclosure, the second semicircle in the intermediate frequency region means the second semicircle close to the ray in the low frequency region in an electrochemical impedance spectroscopy (EIS) spectrum.

According to an implementation of the present disclosure, the slope of the ray in the low frequency region means a slope of an oblique line that intersects the axis of abscissa and appears in the low frequency region.

According to an implementation of the present disclosure, a charge transfer impedance Rct of the second semicircle in the intermediate frequency region meets: 1 mΩ≤Rct<15 mΩ; and preferably, 2 mΩ≤Rct≤14 mΩ, for example, Rct is about 2 mΩ, 3 mΩ, 4 mΩ, 5 mΩ, 6 mΩ, 7 mΩ, 7.1 mΩ, 7.2 mΩ, 7.3 mΩ, 7.4 mΩ, 7.5 mΩ, 7.6 mΩ, 7.7 mΩ, 7.8 mΩ, 7.9 mΩ, 8 mΩ, 8.1 mΩ, 8.2 mΩ, 8.3 mΩ, 8.4 mΩ, 8.5 mΩ, 8.6 mΩ, 8.7 mΩ, 8.8 mΩ, 8.9 mΩ, 9 mΩ, 9.1 mΩ, 9.2 mΩ, 9.3 mΩ, 9.4 mΩ, 9.5 mΩ, 9.6 mΩ, 9.7 mΩ, 9.8 mΩ, 9.9 mΩ, 10 mΩ, 11 mΩ, 12 mΩ, 13 mΩ, or 14 mΩ.

According to an implementation of the present disclosure, a slope k of a ray in the low frequency region meets: 1.05≤k≤56; and preferably, 1.06≤k≤50, for example, k is about 1.06, 1.07, 1.08, 1.09, 1.1, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.4, 1.5, 1.6, 1.7, 1.8, 1.9, 2, 2.5, 2.8, 3, 3.2, 3.5, 3.8, 4, 5, 8, 10, 12, 15, 18, 20, 25, 30, 35, 40, 45, or 50.

According to an implementation of the present disclosure, a condition of the electrochemical impedance spectroscopy (EIS) test is as follows: the highest frequency: 50 kHz to 5 kHz; starting frequency: same as the value of the highest frequency; and the lowest frequency: about 0.01 Hz. Scanning mode is as follows: scanning from high frequency to low frequency. Test mode is POTENTIOSTAT, where AMPLITUDE is 5 mV.

According to an implementation of the present disclosure, an electrochemical impedance spectrum is obtained in the electrochemical impedance spectroscopy (EIS) test. The electrochemical impedance spectroscopy is referred to as a frequency domain impedance analysis method, which is used to study a relationship between electrochemical alternating current impedance and frequency by applying a small amplitude alternating current excitation signal according to the sinusoidal law when an electrochemical battery is in an equilibrium state (open circuit state) or in a specific stable direct current polarization condition. The electrochemical impedance spectroscopy (EIS) records impedances of the electrochemical battery at different response frequencies, and general measurement covers a wide frequency range (from μHz to Mhz). Thus, different electrode processes having differences in reaction time constants may be analyzed.

According to an implementation of the present disclosure, an ionic conductivity of the battery during charging and discharging is mainly obtained through an electrochemical impedance spectroscopy (EIS) test, and a charge transfer impedance Rct and a lithium ion diffusion impedance (also referred to as concentration polarization impedance and Warburg diffusion impedance) are respectively represented by the second semicircle in the intermediate frequency region and a slope of a ray in the low frequency region. Specifically, a less area of the second semicircle in the intermediate frequency region indicates a less charge transfer impedance of the battery; and a greater slope of the ray in the low frequency region indicates a less lithium ion diffusion impedance of the battery. In the electrochemical impedance spectroscopy (EIS) test of the battery, when a charge transfer impedance Rct of the second semicircle in the intermediate frequency region meets: Rct<15 mΩ, and the slope k of the ray in the low frequency region meets: 1.03<k<57.29, it indicates that the battery in the present disclosure has high ionic conductivity; and it also indicates that a positive electrode material of the battery has high ionic conductivity, having an effect of strong overall conductivity of an electrode.

According to an implementation of the present disclosure, the battery includes a positive electrode plate, and the positive electrode plate includes a positive electrode material. The positive electrode material includes several particles having a polymeric single crystal morphology, and the particle having a polymeric single crystal morphology is formed by nesting several primary particles.

The positive electrode material meets a relational expression shown in Formula 1 as follows:

D₅₀³=K×n×d₅₀³ Formula 1,
where K is a coefficient having a range of 0.2≤K≤2; n is a quantity of primary particles having a range of 2≤n≤500; D₅₀ is a median particle size of a positive electrode material, in a unit of μm; and d₅₀ is a median particle size of a primary particle, in a unit of μm.

According to an implementation of the present disclosure, the battery includes a non-aqueous electrolyte solution, and the non-aqueous electrolyte solution includes an additive. The additive is selected from at least one of fluoroethylene carbonate (FEC), vinylene carbonate (VC), vinyl ethylene carbonate (VEC), ethylene sulfate (DTD), 1,3-propane sultone (1,3-PS) or 1,4-butane sultone (1,4-BS).

Beneficial effects of the present disclosure are as follows.

The present disclosure provides a battery, and the battery has a relatively low charge transfer impedance and lithium ion diffusion resistance during charging and discharging, that is, the battery has good lithium ion conductivity performance, so as to improve capacity and C-rate performance of the battery.

It is found through research that dynamic behavior of a battery is a key factor affecting capacity per gram and C-rate performance of the battery in a same condition. During charging and discharging of the battery, lithium ions and electrons are transported inside a battery plate, where the lithium ions in particles are transported through an electrolyte solution filled in electrode pores, and the electrons are mainly conducted to active material particle/electrolyte solution interface through a three-dimensional network composed of solid particles, especially a conductive agent, to participate in electrode reaction. In an electrode material, generally reduction of a particle size of primary particles of an active material often improves an ionic conductivity of the electrode material, thereby increasing an overall conductivity of an electrode and improving capacity and C-rate performance of a battery. The main reason is that when the particle size of the primary particles of the active material decreases, a diffusion path of Li⁺ in the electrode material is shortened, facilitating transmission of Li⁺.

A positive electrode material in the battery of the present disclosure has a polymeric single crystal morphology, and a specific surface area of the positive electrode material having a polymeric single crystal morphology is 5%-40% larger than that of a positive electrode material having a dispersed single crystal morphology, so that the positive electrode material having a polymeric single crystal morphology can be well soaked by an electrolyte solution, thereby improving an ionic conductivity of a battery plate, that is, added positive electrode material having a polymeric single crystal structure morphology can improve an ionic conductivity of the positive electrode plate. During charging and discharging of the battery, lithium ions inside the plate of the battery are transported through the electrolyte solution filled in electrode pores. Compared with an active material in a positive plate, a contact area between the electrolyte solution and active material particles and a degree of infiltration of the active material particles into the electrolyte solution directly affect a migration rate of lithium ions, thus reducing the ionic conductivity. In addition, a particle morphology of the active material also has a great impact on the migration rate of lithium ions. A specific surface area of the polymeric single crystal positive electrode material used in the present disclosure is significantly increased compared with a specific surface area of the dispersed single crystal active positive electrode material, so that the electrolyte solution may fully infiltrate the polymeric single crystal positive electrode material. Furthermore, the positive electrode material having a polymeric single crystal morphology is formed by nesting several primary particles, and is different from a secondary sphere ternary material being formed by piling up countless tiny particles. A formation mode of a polymeric single crystal makes a quantity of primary particles of the polymeric single crystal significantly reduced compared with that of primary particles of the secondary sphere ternary material, thus weakening stress between different particles from different directions, avoiding a phenomenon of large-area particle breakage caused by rolling, and further stabilizing a morphological structure of polymeric single crystal particles. For the dispersed single crystal morphology, due to the relatively large particle size of primary particles, the primary particles are relatively dispersed and the specific surface area is relatively small. On the one hand, compared with the polymeric single crystal, the dispersed single crystal has a narrower contact range with the electrolyte solution, and thus full infiltration of the electrolyte solution cannot be implemented, a migration rate of lithium ions is slowed down, and the ionic conductivity is weakened. On the other hand, since the particle size of the primary particles of the dispersed single crystal is larger than that of the polymeric single crystal, a migration path of lithium ions becomes longer and the ionic conductivity becomes low, and accordingly charge transfer impedance and lithium ion diffusion impedance in the electrochemical impedance spectroscopy test are relatively large.

The battery plate containing a positive electrode material having a polymeric single crystal morphology according to the present disclosure is not easy to be broken by rolling, an electrolyte solution is fully infiltrated, and a diffusion path of an electrode material is short during charging and discharging of a lithium-ion battery, so that the lithium-ion battery containing a polymeric single crystal active positive electrode material has a relatively low charge transfer impedance and lithium ion diffusion impedance during charging and discharging, that is, the battery has good lithium ion conductivity performance, so as to improve capacity and C-rate performance of the battery.

### BRIEF DESCRIPTION OF THE DRAWINGS

FIG. 1 is an SEM electron microscope diagram (polymeric single crystal) of a ternary material in Example 1.

FIG. 2 is an SEM electron microscope diagram (single crystal) of a ternary material in Comparative example 1.

FIG. 3 is an alternating current impedance EIS spectrum of batteries in Example 1 and Comparative Example 1.

### DETAILED DESCRIPTIONS OF THE EMBODIMENTS

Positive Electrode Material

As described above, a battery in the present disclosure includes a positive electrode material, where the positive electrode material includes several particles having a polymeric single crystal morphology, and the particle having a polymeric single crystal morphology is formed by nesting several primary particles. The positive electrode material meets a relational expression shown in Formula 1 as follows:

D₅₀³=K×n×d₅₀³ Formula 1,
where K is a coefficient having a range of 0.2≤K≤2; n is a quantity of primary particles having a range of 2≤n≤500; D₅₀ is a median particle size of a positive electrode material, in a unit of μm; and d₅₀ is a median particle size of a primary particle, in a unit of μm.

In an implementation, K is 0.2, 0.3, 0.4, 0.5, 0.6, 0.7, 0.8, 0.9, 1.0, 1.1, 1.2, 1.3, 1.4, 1.5, 1.6, 1.7, 1.8, 1.9 or 2.0.

In an implementation, n is 2, 5, 10, 20, 50, 80, 90, 100, 120, 130, 150, 180, 200, 220, 230, 240, 250, 260, 280, 300, 320, 340, 350, 380, 400, 420, 430, 450, 480, 490 or 500. In the present disclosure, n may be obtained through testing by using a conventional method in the art, for example, by using an SEM+FIB technology (a technology combining scanning electron microscope and focused ion beam).

In the present disclosure, a median particle size D₅₀ of the positive electrode material and a median particle size d₅₀ of the primary particle may be obtained by using a conventional method in the art, for example, the median particle diameter D₅₀ of the positive electrode material may be obtained by a laser particle size analyzer or SEM (scanning electron microscope) image recognition; the median particle diameter d₅₀ of the primary particle may be measured by SEM image recognition after cutting is performed by using a focused ion beam technology; or may be directly measured by SEM image recognition.

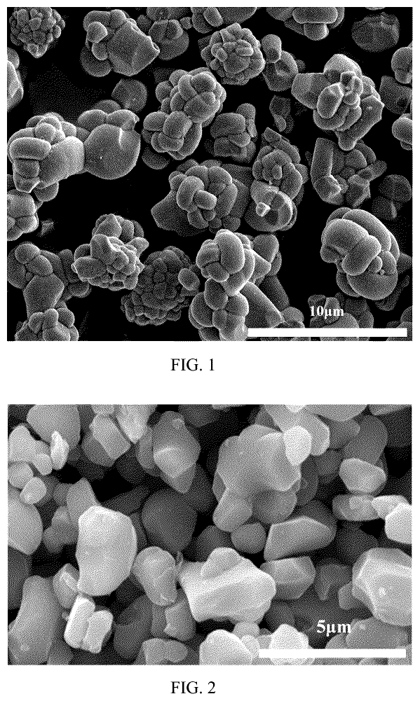

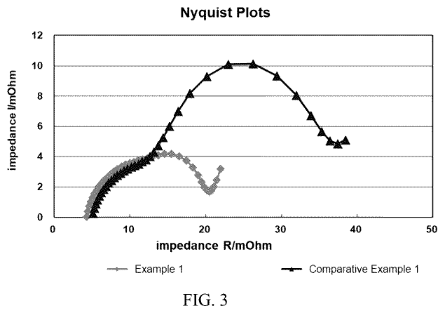

In an implementation, the particles having a polymeric single crystal morphology in the positive electrode material are formed by nesting several primary particles. The nesting in the present disclosure is not a core-shell structure, and a core-shell structure has an obvious core structure and a shell structure. The particles having a polymeric single crystal morphology in the present disclosure are formed by nested aggregation of several primary particles, that is, in the formed particles having a polymeric single crystal morphology, one primary particle and a plurality of primary particles are fused and connected in a nested manner through an internal force to form a surrounding structure, for example, as shown in FIG. 1.

In an implementation, the several refers to one or two or more.

In an implementation, the particle having a polymeric single crystal morphology is formed by nesting 2-500 (for example, 5-100) primary particles.

In an implementation, a surface of the particle having a polymeric single crystal morphology is relatively smooth.

In an implementation, a structure of the polymeric single crystal morphology of the particle is different from a single crystal structure in the conventional technology, and is also different from a secondary sphere structure. The secondary sphere structure generally exists in a ternary material, and a secondary sphere particle known in the field of the ternary material is a regular sphere-like particle. The secondary sphere particle may also be referred to as a polycrystalline material. A primary particle of the secondary sphere particle is greatly different from a single crystal, a quasi-single crystal, and the polymeric single crystal in the present disclosure, and growth manners thereof are also different.

In an implementation, a median particle size d₅₀ of the primary particle ranges from 0.1 μm to 3 μm, and is, for example, 0.1 μm, 0.2 μm, 0.3 μm, 0.4 μm, 0.5 μm, 0.6 μm, 0.7 μm, 0.8 μm, 0.9 μm, 1 μm, 1.1 μm, 1.2 μm, 1.3 μm, 1.4 μm, 1.5 μm, 1.6 μm, 1.7 μm, 1.8 μm, 1.9 μm, 2 μm, 2.1 μm, 2.2 μm, 2.3 μm, 2.4 μm, 2.5 μm, 2.6 μm, 2.7 μm, 2.8 μm, 2.9 μm, or 3 μm.

In an implementation, a median particle size D₅₀ of the positive electrode material ranges from 0.2 μm to 20 μm, and is, for example, 0.2 μm, 0.3 μm, 0.4 μm, 0.5 μm, 0.6 μm, 0.7 μm, 0.8 μm, 0.9 μm, 1 μm, 1.1 μm, 1.2 μm, 1.3 μm, 1.4 μm, 1.5 μm, 1.6 μm, 1.7 μm, 1.8 μm, 1.9 μm, 2 μm, 2.1 μm, 2.2 μm, 2.3 μm, 2.4 μm, 2.5 μm, 2.6 μm, 2.7 μm, 2.8 μm, 2.9 μm, 3 μm, 3.5 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm.

In an implementation, the primary particle is a ternary material. The ternary material may include at least one of a ternary material on which doping and/or encapsulation processing is performed and a ternary material on which doping and/or encapsulation processing is not performed.

In an implementation, a chemical formula of the ternary material is LiₐNi_{1-x-y-p}CoₓM¹_{y}M²ₚO₂, where 0.95≤a<1.08, 0.5≤1−x−y−p<1.0, 0<x≤0.3, 0<y≤0.2, and 0<p≤0.005; and M¹ is Mn or Al, and M² is one or more of Mg, Sr, Ba, Y, W, Nb, or Mo. Preferably, 0.0005≤p<0.005.

In an implementation, the positive electrode material further includes a coating layer, and the coating layer covers a surface of the particles having a polymeric single crystal morphology.

In an implementation, a mass of the coating layer ranges from 500 ppm to 10000 ppm, and is, for example, 500 ppm, 600 ppm, 700 ppm, 800 ppm, 900 ppm, 1000 ppm, 1500 ppm, 1800 ppm, 2000 ppm, 2500 ppm, 3000 ppm, 3500 ppm, 4000 ppm, 4500 ppm, 5000 ppm, 5500 ppm, 6000 ppm, 6500 ppm, 7000 ppm, 7500 ppm, 8000 ppm, 9500 ppm, or 10000 ppm; that is, the mass of the coating layer accounts for 0.05 wt % to 1 wt % of a total mass of the positive electrode material, and is, for example, 0.05 wt %, 0.06 wt %, 0.07 wt %, 0.08 wt %, 0.09 wt %, 0.1 wt %, 0.15 wt %, 0.2 wt %, 0.25 wt %, 0.3 wt %, 0.35 wt %, 0.4 wt %, 0.45 wt %, 0.5 wt %, 0.55 wt %, 0.6 wt %, 0.65 wt %, 0.7 wt %, 0.75 wt %, 0.8 wt %, 0.85 wt %, 0.9 wt %, 0.95 wt %, or 1 wt %.

In an implementation, a mass of the coating layer ranges from 500 ppm to 5000 ppm, and is, for example, 500 ppm, 600 ppm, 700 ppm, 800 ppm, 900 ppm, 1000 ppm, 1500 ppm, 1800 ppm, 2000 ppm, 2500 ppm, 3000 ppm, 3500 ppm, 4000 ppm, 4500 ppm, or 5000 ppm; that is, the mass of the coating layer accounts for 0.05 wt % to 0.5 wt % of the total mass of the positive electrode material, and is, for example, 0.05 wt %, 0.06 wt %, 0.07 wt %, 0.08 wt %, 0.09 wt %, 0.1 wt %, 0.15 wt %, 0.2 wt %, 0.25 wt %, 0.3 wt %, 0.35 wt %, 0.4 wt %, 0.45 wt %, or 0.5 wt %.

In an implementation, a material forming the coating layer is a metal compound and/or a non-metal compound.

In an implementation, the metal compound is selected from at least one of aluminum oxide, tungsten oxide, molybdenum oxide, zirconium oxide, or titanium oxide.

In an implementation, the non-metal compound is selected from boron oxide.

In an implementation, the coating layer includes a first coating layer and a second coating layer, the first coating layer covers a surface of the particles having a polymeric single crystal morphology, the second coating layer covers an outer surface of the first coating layer, the first coating layer is a metal compound, and the second coating layer is a metal compound and/or a non-metal compound.

Preparation of a Positive Electrode Material

The present disclosure further provides a method for preparing the foregoing positive electrode material, where the method includes the following steps:

Step S11: uniformly mixing a ternary precursor with D₅₀ less than 7 μm, a lithium source, and a doping modifier to obtain a precursor mixture; and

Step S12: Performing first calcination on the precursor mixture.

In an implementation, the method further includes the following steps:

Step S13: adding a first coating agent into the material obtained in Step S12, and then performing mixing and first heat treatment; and

Step S14: adding a second coating agent to the material obtained in Step S13, and then performing mixing, followed by second heat treatment, third pulverization, and sixth sieving.

In an implementation, in Step S11, the ternary precursor is Ni_{1-x-y}CoₓM¹_{y}(OH)₂, where 0.5≤1−x−y<1.0, 0<x≤0.3, 0<y≤0.2, and M¹ is Mn or Al.

In an implementation, in Step S11, the lithium source is selected from one or more of lithium hydroxide, lithium nitrate, lithium sulfate, lithium chloride, lithium carbonate, lithium phosphate, lithium fluoride, lithium acetate, lithium oxalate, or lithium hydrogen phosphate.

In an implementation, in Step S11, the doping modifier includes one or more of the following doping elements: Mg, Sr, Ba, Y, W, Nb, or Mo, and an added amount of the doping modifier based on the doping element ranges from 0 ppm to 5000 ppm (0 ppm is excluded). The first doping modifier may include at least one of an oxide and a hydroxide of the foregoing doping elements.

In an implementation, in Step S11, a molar ratio of the lithium source to the ternary precursor is (1.01-1.15):1.

In an implementation, in Step S11, the mixing is, for example, dry ball milling, a ball milling medium is a zirconia ball or a steel ball, a speed ranges from 200 r/min to 800 r/min, and a duration ranges from 3 hours to 6 hours.

According to an implementation of the present disclosure, Step S12 further includes: performing first sieving before the first calcination.

In an implementation, in Step S12, the first calcination is performed in an air atmosphere or an oxygen atmosphere, preferably in an oxygen atmosphere.

In an implementation, in Step S12, the first calcination is performed by increasing a temperature to 400° C.-600° C. at 2° C./min-15° C./min and keeping the temperature for 1 hours-6 hours, then increasing the temperature to 700° C.-800° C. at 2° C./min-15° C./min and keeping the temperature for 2 hours-12 hours, finally increasing the temperature to 800° C.-920° C. at 2° C./min-15° C./min and keeping the temperature for 2 hours-16 hours, followed by naturally cooling.

In an implementation, in Step S12, first pulverization and second sieving are performed on the material obtained after the first calcination to obtain a polymeric single crystal ternary positive electrode material.

In an implementation, in Step S13, the first coating agent is a metal compound. The metal compound is at least one of a nanometer oxide, a nanometer hydroxide, or a nanometer salt of a metal element, and the metal element is selected from at least one of Al, Ti, Zr, Mo, or W. A nanometer oxide or nanometer hydroxide of Al, Ti or W is preferred. A mass of the first coating agent accounts for 0.05 wt %-0.50 wt % of a mass of the polymeric single crystal ternary positive electrode material.

In an implementation, in Step S13, the mixing is high-speed mixing (for example, performed by using a high-speed mixer).

According to an implementation of the present disclosure, Step S13 further includes: performing third sieving before the first heat treatment.

In an implementation, in Step S13, the first heat treatment is performed at a constant temperature in an oxygen-containing environment.

In an implementation, in Step S13, the first heat treatment at a constant temperature is performed by increasing a temperature to 200° C.-900° C. at 2° C./min-15° C./min and keeping the temperature for 3 hours-16 hours.

According to an implementation of the present disclosure, in Step S13, second pulverization and fourth sieving are performed on the material obtained after the first heat treatment.

In an implementation, in Step S14, the second coating agent is at least one of a metal compound and/or a non-metal compound. The metal compound is at least one of a nanometer oxide, a nanometer hydroxide, or a nanometer salt of a metal element, and the metal element is selected from at least one of Al, Ti, Zr, Mo, or W. A nanometer oxide or nanometer hydroxide of Al, Ti or W is preferred. The non-metal compound is selected from boron oxide. A mass of the second coating agent accounts for 0.05 wt %-0.50 wt % of the mass of the polymeric single crystal ternary positive electrode material.

According to an implementation of the present disclosure, Step S14 further includes: performing fifth sieving before the second heat treatment.

In an implementation, in Step S14, the mixing is high-speed mixing (for example, performed by using a high-speed mixer).

In an implementation, in Step S14, the second heat treatment is performed at a constant temperature in an oxygen-containing environment.

In an implementation, in Step S14, the second heat treatment at a constant temperature is performed by increasing a temperature to 200C°-900C° at 2C°/min-15C°/min and keeping the temperature for 2 hours-16 hours.

In the conventional technology, a secondary sphere structure generally exists in a ternary material and needs to be synthesized and prepared by using a precursor with D₅₀>7 However, in the preparation method of the present disclosure, a precursor of a ternary material with D₅₀<7 μm (D₅₀ is, for example, 1 μm, 2 μm, 3 μm, 4 μm, 5 μm, 6 μm, 6.5 μm, or a range formed by the foregoing any two point values) is used to prepare the particle having a polymeric single crystal morphology. Growth of a primary particle of the particle having a polymeric single crystal morphology tends to grow in a direction of single crystal, thereby avoiding completely forming a dispersion structure of single crystal.

Positive Electrode Plate

The battery of the present disclosure further provides a positive electrode plate, and the positive electrode plate includes the foregoing positive electrode material.

According to an implementation, the positive electrode plate includes a positive electrode current collector and a positive electrode active material layer disposed on at least one surface of the positive electrode current collector, and the positive electrode active material layer includes the foregoing positive electrode material.

Battery

As described above, the present disclosure further provides a battery, and in an electrochemical impedance spectroscopy (EIS) test of the battery, a charge transfer impedance Rct of the second semicircle in an intermediate frequency region meets: Rct<15 mΩ; and a slope k of a ray in a low frequency region meets: 1.03<k<57.29.

In an implementation, the battery meets the foregoing various limitations.

In an implementation, the battery includes the foregoing positive electrode material or the foregoing positive electrode plate.

Preparation of the Battery

The present disclosure provides a preparation method for the foregoing battery, including the following steps:
Step S21: weighing 100 g of the positive electrode material, a conductive agent Super P, and a binder polyvinylidene fluoride (PVDF) according to a weight ratio of 96:2:2 in sequence, mixing them in 40 g N-methylpyrrolidone (NMP), stirring the mixture in vacuum to obtain a uniform slurry, then applying the slurry on an aluminum foil current collector evenly, performing roll baking at 100° C. in a 10 m oven (with a rolling belt at 2 m/min) and vacuum baking at 85° C. for 20 hours, and then performing cold pressing and slitting to obtain a positive electrode plate;
Step S22: weighing 100 g of artificial graphite: conductive agent Super P: carboxymethyl cellulose (CMC): styrene-butadiene rubber (SBR) according to a weight ratio of 95:2:1.5:1.5 in sequence, mixing them in 40 g deionized water, stirring the mixture in vacuum to obtain a uniform slurry, then applying the slurry on a copper foil current collector evenly, performing roll baking at 100° C. in a 10 m oven (with a rolling belt at 2 m/min) and vacuum baking at 85° C. for 20 hours, and then performing cold pressing and slitting to obtain a negative electrode plate;
Step S23: stacking the positive electrode plate, the negative electrode plate, and a separator to form a lithium-ion cell, packing the lithium-ion cell in a pouch battery package, and injecting an electrolyte solution with ethyl carbonate (EC) containing 1 mol/L lithium hexafluorophosphate (LiPF₆): methyl ethyl carbonate (EMC): diethyl carbonate (DEC)=1:1:1 (volume ratio), and with 2 wt % vinylene carbonate (VC) and 3 wt % 1,3-propane sultone (1,3-PS); and
Step S24: after steps such as hot pressing, formation, cold pressing, aging, secondary sealing, and sorting, obtaining a lithium-ion battery that uses polymeric single crystal ternary positive electrode as a positive active material.

The present disclosure provides another preparation method for the foregoing battery, including the following steps:
Step S31: weighing the positive electrode material, a conductive agent Super P, and a binder PVDF according to a weight ratio of 96:2:2 in sequence and mixing them in NMP, stirring the mixture in vacuum to obtain a uniform slurry, then applying the slurry on an aluminum foil current collector evenly, and performing roll baking at 100° C. in an oven for 12 hours and then slitting to obtain a small positive disk containing the positive electrode material; and
Step S32: preparing a button cell, where the positive electrode plate is obtained in S31, the negative electrode is a lithium plate, the separator is a conventional separator, and the electrolyte solution is an electrolyte solution with ethyl carbonate (EC) containing 1 mol/L lithium hexafluorophosphate (LiPF₆): methyl ethyl carbonate (EMC): diethyl carbonate (DEC)=1:1:1 (volume ratio), and with 2 wt % vinylene carbonate (VC) and 3 wt % 1,3-propane sultone (1,3-PS); and performing stamping to obtain a button battery of model 2016.

The present disclosure will be further described in detail below with reference to specific embodiments. It should be understood that the following examples are only for illustrating and explaining the present disclosure, and should not be construed as limiting the protection scope of the present disclosure. All technologies implemented based on the foregoing contents of the present disclosure are within the scope of protection of the present disclosure.

Experimental methods used in the following examples are conventional methods, unless otherwise specified. Reagents, materials, and the like used in the following examples are all commercially available, unless otherwise specified.

Testing of an initial DC internal resistance in the following Examples is as follows: 1. standing for 10 minutes; 2. discharging to a cut-off voltage of 2.75 V at 0.2C; and 3. standing for 10 minutes; setting aside at a corresponding test temperature for a period of time until a stable state is reached (the duration should not be less than 2 hours), and performing discharge for a specific period of time with a specific pulse current, so as to calculate DCIR.

### Example 1

(1) Ni_{0.65}Co_{0.15}Mn_{0.2}(OH)₂ with D₅₀ ranging from 3 μm to 7 μm (excluding 7 μm) and Li₂CO₃ were mixed in a high-speed mixing manner at 400 r/min according to a molar ratio Li/(Ni+Co+Mn) of 1.05:1, and then a specific amount of nanometer Mo₂O₃ and nanometer WO₃ were added and further mixed in a high-speed mixing manner at 400 r/min. A molar ratio of added Mo₂O₃ to Ni_{0.65}Co_{0.15}Mn_{0.2}(OH)₂ is 0.2%, and a molar ratio of added WO₃ to Ni_{0.65}Co_{0.15}Mn_{0.2}(OH)₂ is 0.3%. The mixture was put into a sagger and sintered for the first time in a box furnace, and oxygen was introduced as sintering atmosphere. The synthesis was performed mainly in three stages at constant temperature, and a heating rate between the stages was set to 2° C./min: a low-temperature stage was kept at 400° C. for 1 hour; a medium-temperature stage was kept at 700° C. for 2 hours; and a high-temperature stage was kept at 900° C. for 12 hours. Then, after the box furnace was cooled naturally, the material was taken out and pulverized by jet, and then sieved with a 300-mesh sieve to obtain a polymeric single crystal ternary material.

In the polymeric single crystal ternary material, a quantity n of primary particles ranges from 5 to 100, and a median particle size D₅₀ of the positive electrode material is 4.08 μm (an average value is taken after three times of test is performed by using a laser particle size analyzer); and a median particle size d₅₀ of the primary particles ranges from 0.2 μm to 1.5 μm.

The following relational expression shown in Formula 1 is met:

D₅₀³=K×n×d₅₀³ Formula 1,
where K ranges from 0.3 to 2.

The obtained polymeric single crystal ternary material was evenly mixed with nanometer Al₂O₃, where Al₂O₃ and the polymeric single crystal ternary material were designed at a mass ratio of 1000 ppm. Sintering was performed for the second time by increasing a temperature to 600° C. at 2° C./min in an oxygen atmosphere and keeping the temperature for 10 hours. After cooling, a single-layer coated polymeric single crystal ternary material was obtained. The obtained single-layer coated polymeric single crystal ternary material was evenly mixed with nanometer WO₃, where WO₃ and the single-layer coated polymeric single crystal ternary material were designed according to a mass ratio of 2000 ppm. Sintering was performed for the third time by increasing a temperature to 500° C. at 2° C./min in an oxygen atmosphere and keeping the temperature for 10 hours. After cooling, a double-layer coated polymeric single crystal ternary positive electrode material was obtained. A scanning electron microscope image is shown in FIG. 1.

(2) The polymeric single crystal positive electrode material, a conductive agent Super P, and a binder PVDF were weighed according to a weight ratio of 96:2:2 in sequence and mixed in NMP. The mixture was stirred in vacuum to obtain a uniform slurry. Then the slurry was applied on an aluminum foil current collector evenly, followed by roll baking at 100° C. in an oven for 12 hours and slitting, so as to obtain a small positive disk containing a positive electrode material.

Button cell preparation: A positive shell, a positive disk, a separator, a negative lithium plate, a gasket, an elastic sheet, and a negative shell were placed in sequence, an electrolyte solution (with ethyl carbonate (EC) containing 1 mol/L lithium hexafluorophosphate (LiPF₆): methyl ethyl carbonate (EMC): diethyl carbonate (DEC)=1:1:1 (volume ratio), and with 2 wt % vinylene carbonate (VC) and 3 wt % 1,3-propane sultone (1,3-PS)) was added. After stamping, a button battery of model 2016 was obtained.

Electrical performance test: All tests were conducted in a voltage range from 4.4 V to 3 V. Capacity per gram test condition: charging at 0.1C, and discharging at 0.1C. C-rate test condition: step 1: charging at 0.5C/discharging at 0.1C; step 2: charging at 0.5C/discharging at 0.2C; step 3: charging at 0.5C/discharging at 0.5C; and step 4: charging at 0.5C/discharging at 1C. EIS test: 1. standing for 30 minutes; 2. discharging at 0.5C to a lower limit voltage; 3. standing for 30 minutes; 4. charging at a constant current at 1C to an upper limit voltage; 5. standing still for 2 hours, and then testing a voltage and an internal resistance in a full-charge state at 25° C.+5° C.; and 6. performing an electrochemical impedance spectroscopy (EIS) test, where parameters are as follows: the highest frequency: 50 kHz to 5 kHz; starting frequency: same as the value of the highest frequency; and the lowest frequency: about 0.01 Hz. Scanning mode: scanning from high frequency to low frequency. Test mode: POTENTIOSTAT mode, where AMPLITUDE is 5 mV.

(3) 100 g of the polymeric single crystal positive electrode material, a conductive agent Super P, and a binder PVDF were weighed according to a weight ratio of 96:2:2 in sequence and mixed in 40 g NMP. The mixture was stirred in vacuum to obtain a uniform slurry. Then the slurry was applied on an aluminum foil current collector evenly, followed by roll baking at 100° C. in a 10 m oven (with a rolling belt at 2 m/min) and vacuum baking at 85° C. for 20 hours, cold pressing, and slitting, so as to obtain a positive electrode plate containing a double-layer coated polymeric single crystal ternary positive electrode material. 100 g of artificial graphite: conductive agent Super P: CMC: SBR were weighed according to a weight ratio of 95:2:1.5:1.5 in sequence, and mixed in 40 g deionized water. The mixture was stirred in vacuum to obtain a uniform slurry. Then the slurry was applied on a copper foil current collector evenly, followed by roll baking at 100° C. in a 10 m oven (with a rolling belt at 2 m/min) and vacuum baking at 85° C. for 20 hours, cold pressing, and slitting, so as to obtain a negative electrode plate.

Preparation of a lithium-ion battery: a positive electrode plate, a negative electrode plate, and a separator were stacked to form a lithium-ion cell; the lithium-ion cell are packed in a pouch battery package, and an electrolyte solution with ethyl carbonate (EC) containing 1 mol/L lithium hexafluorophosphate (LiPF₆): methyl ethyl carbonate (EMC): diethyl carbonate (DEC)=1:1:1 (volume ratio), and with 2 wt % vinylene carbonate (VC) and 3 wt % 1,3-propane sultone (1,3-PS) was injected; and after steps such as hot pressing, formation, cold pressing, aging, secondary sealing, and sorting, a lithium-ion battery that uses a double-layer coated polymeric single crystal ternary positive electrode material as a positive active material was obtained.

Electrical performance test: The lithium-ion battery was allowed to stand in a room temperature environment of 25° C. for 24 hours, charged to 4.3 V at a current rate of 0.1C of a sorting capacity, and allowed to stand for 10 minutes and then discharged at a current rate of 0.1C of a design capacity until the voltage became 3.0 V. The discharge capacity this time was used as a reference, and the battery was charged to 4.3 V at 0.1C, 0.2C, 0.5C, 1.0C, 2.0C, 5C, and 10C, separately after being left to stand for 10 minutes, and then discharged at a charging current rate until the discharge voltage became 3.0 V. An interval between each charging and discharging was 10 minutes, charging and discharging at each C-rate was cycled five times, and the discharge C-rate was calculated. The test results are shown in Table 3.

The lithium-ion battery was allowed to stand in a constant temperature environment of for 24 hours, charged to 4.3 V with the current rate of 1C, and charged at a constant voltage of 4.3 V, with a cut-off current being 0.05C. Then the lithium-ion battery was allowed to stand for 10 minutes and then discharged at a same current until the voltage became 3.0 V, forming a charge-discharge cycle. After the lithium-ion battery was allowed to stand for 10 minutes, a next cycle was performed, and the whole cycle was performed in an environment of 45° C. The test results are shown in Table 3.

### Comparative Example 1

(1) Ni_{0.65}Co_{0.15}Mn_{0.2}(OH)₂ with D₅₀ less than 10 μm and Li₂CO₃ were mixed in a high-speed mixing manner at 400 r/min according to a molar ratio Li/(Ni+Co+Mn) of 1.05:1.0. The mixture was put into a sagger and sintered for the first time in a box furnace, and oxygen was introduced as sintering atmosphere. The sintering was performed at 930° C. for 24 hours; and after the box furnace was cooled naturally, the material was taken out and pulverized, and then sieved with a 300-mesh sieve. Then, after a muffle furnace was cooled naturally, the material was taken out and pulverized by jet, and then sieved with a 300-mesh sieve to obtain a single crystal ternary material. A scanning electron microscope image is shown in FIG. 4.

The obtained single crystal ternary material was evenly mixed with nanometer Al₂O₃, where Al₂O₃ and Li_{1.05}Ni_{0.65}Co_{0.15}Mn_{0.2}O₂ were designed according to a molar ratio of 1000 ppm. Sintering was performed for the second time at 600° C. for 10 hours in an oxygen atmosphere. After cooling, a single-layer coated single crystal ternary material was obtained.

In the single crystal ternary material, a quantity n of primary particles is 1, and a median particle size D₅₀ of the positive electrode material is 3.56 μm (an average value is taken after three times of test is performed by using a laser particle size analyzer); and a median particle size d₅₀ of the primary particles is 3.56 μm.

(2) The single-layer coated single crystal ternary material, a conductive agent Super P, and a binder PVDF were weighed according to a weight ratio of 96:2:2 in sequence and mixed in NMP. The mixture was stirred in vacuum to obtain a uniform slurry. Then the slurry was applied on an aluminum foil current collector evenly, followed by roll baking at 100° C. in an oven for 12 hours and slitting, so as to obtain a small positive disk containing a positive electrode material.

(3) A button battery of model 2016 and a lithium-ion battery were prepared and corresponding performance tests same as those in Example 1 were performed.

TABLE 1
Capacity per gram and C-rate performance data for the button
batteries of model 2016 in Example 1 and Comparative Example 1

| | Capacity per | Capacity per | Capacity per | Capacity per |
|---|---|---|---|---|
| | gram for | gram for | gram for | gram for |
| | discharging | discharging | discharging | discharging |
| | at 0.1 C | at 0.2 C | at 0.5 C | at 1.0 C |
| | (mAh/g) | (mAh/g) | (mAh/g) | (mAh/g) |
| Example 1 | 201.22 | 196.34 | 190.23 | 185.76 |
| Comparative | 199.56 | 195.23 | 187.64 | 181.23 |
| Example 1 | | | | |

TABLE 2
EIS test data for the button batteries of model 2016 in
Example 1 and Comparative Example 1

| | Charge transfer | Warburg impedance ray |
|---|---|---|
| | impedance (Rct/mΩ) | slope k |
| Example 1 | 8.137 | 1.19 |
| Comparative | 25.233 | 0.23 |
| Example 1 | | |

The test results in Table 1 show that the polymeric single crystal in the present disclosure has a higher capacity per gram for discharging at 0.1C than the single crystal, and also has advantages in C-rate performance, especially when C-rate is increased to 0.5C and 1C, the capacities per gram for discharging have obvious advantages. The test results in Table 2 show that charge transfer impedance and lithium ion diffusion impedance of the polymeric single crystal have great advantages compared with the single crystal, which can fully indicate that the polymeric single crystal material in the present disclosure has good ionic conductivity, good charge-discharge capacity, and good C-rate performance when being applied to a lithium-ion battery.

TABLE 3
Performance test results for the lithium-ion batteries in Example 1 and Comparative Example 1

| | | | | | | | | | Capacity |
|---|---|---|---|---|---|---|---|---|---|
| | | | | | | | | | retention |
| | | | | | | | | | rate after |
| | 0.1 C | | | | | | | | 1200 |
| | discharge | | | | | | | | cycles at |
| | capacity | Discharge capacity retention rate at different C-rates (%) | | | | | | | constant |
| | (mAh/g) | 0.1 C | 0.2 C | 0.5 C | 1.0 C | 2.0 C | 5.0 C | 10.0 C | 45° C. (%) |
| Example 1 | 180.1 | 100.00% | 98.95% | 97.59% | 96.95% | 96.54% | 96.50% | 96.72% | 89.42% |
| Comparative | 178.2 | 100.00% | 98.92% | 97.60% | 96.04% | 96.20% | 95.19% | 94.66% | 89.79% |
| Example 1 | | | | | | | | | |

According to data in Table 3, the battery in Example 1 may reach 180.1 mAh/g when being discharged from the upper limit voltage 4.3 V to 3.0 V, with 89.42% capacity retention rate after 1200 cycles at 45° C. under this voltage. In Example 1 and Comparative Example 1, the particle size of the precursor was adjusted, and a substance containing Mo and W was added during the synthesis to regulate a growth mode of the primary particles and calcination temperature, so that a polymeric single crystal morphology and a single crystal morphology are separately formed. It may be clearly learned from Table 3 that the C-rate performance of the polymeric single crystal material is much higher than that of the single crystal material at high voltage up to 4.3 V and high C-rate cycling, which makes the battery have good cycling performance and improved capacity, as well as good C-rate performance.

The implementations of the present disclosure have been illustrated above. However, the present disclosure is not limited to the foregoing implementations. Any modification, equivalent replacement, improvement, or the like, made within the spirit and principles of the present disclosure shall fall within the protection scope of the present disclosure.

What is claimed is:

1. A battery, wherein in an electrochemical impedance spectroscopy test of the battery, a charge transfer impedance Rct of the second semicircle in an intermediate frequency region meets: Rct<15 mΩ; and a slope k of a ray in a low frequency region meets: 1.03<k<57.29.

2. The battery according to claim 1, wherein a frequency of the intermediate frequency region ranges from 150 Hz to 500 Hz, and a frequency of the low frequency region ranges from 0.01 Hz to 150 Hz.

3. The battery according to claim 1, wherein 2 mΩ≤Rct≤14 mΩ.

4. The battery according to claim 1, wherein 1.05≤k≤56.

5. The battery according to claim 4, wherein 1.06≤k≤50.

6. The battery according to claim 1, comprising a positive electrode plate, wherein the positive electrode plate comprises a positive electrode material, the positive electrode material comprises several particles having a polymeric single crystal morphology, and the particle having a polymeric single crystal morphology is formed by nesting several primary particles; and
the positive electrode material meets a relational expression shown in Formula 1 as follows:
D₅₀³=K×n×d₅₀³ Formula 1,
wherein K is a coefficient having a range of 0.2≤K≤2; n is a quantity of the primary particles having a range of 2≤n≤500; D₅₀ is a median particle size of the positive electrode material, in a unit of μm; and d₅₀ is a median particle size of the primary particle, in a unit of μm.

7. The battery according to claim 6, wherein 5≤n≤100.

8. The battery according to claim 6, wherein a median particle size d₅₀ of the primary particles ranges from 0.1 μm to 3 μm.

9. The battery according to claim 6, wherein a median particle size D₅₀ of the positive electrode material ranges from 0.2 μm to 20 μm.

10. The battery according to claim 6, wherein the primary particle is a ternary material, and a chemical formula of the ternary material is LiₐNi_{1-x-y-p}CoₓM¹_{y}M²ₚO₂, wherein 0.95≤a<1.08, 0.5≤1−x−y−p<1.0, 0<x≤0.3, 0<y≤0.2, and 0<p≤0.005; and M¹ is Mn or Al, and M² is one or more of Mg, Sr, Ba, Y, W, Nb, or Mo.

11. The battery according to claim 10, wherein 0.0005≤p≤0.005.

12. The battery according to claim 6, wherein the particle having a polymeric single crystal morphology is prepared by using a precursor of a ternary material with D₅₀<7 μm.

13. The battery according to claim 6, wherein the positive electrode material further comprises a coating layer, and the coating layer covers a surface of the particles having a polymeric single crystal morphology; and a material forming the coating layer is a metal compound and/or a non-metal compound.

14. The battery according to claim 13, wherein a mass of the coating layer accounts for 0.05 wt %-1 wt % of a total mass of the positive electrode material.

15. The battery according to claim 14, wherein the mass of the coating layer accounts for 0.05 wt %-0.5 wt % of the total mass of the positive electrode material.

16. The battery according to claim 13, wherein the coating layer comprises a first coating layer and a second coating layer, the first coating layer covers a surface of the particles having a polymeric single crystal morphology, the second coating layer covers an outer surface of the first coating layer, the first coating layer is a metal compound, and the second coating layer is a metal compound and/or a non-metal compound.

17. The battery according to claim 13, wherein the metal compound is selected from at least one of aluminum oxide, tungsten oxide, molybdenum oxide, zirconium oxide, or titanium oxide; and/or
the non-metal compound is selected from boron oxide.

18. The battery according to claim 16, wherein a mass of the first coating layer accounts for 0.05 wt %-0.5 wt % of a total mass of the positive electrode material.

19. The battery according to claim 16, wherein a mass of the second coating layer accounts for 0.05 wt %-0.5 wt % of a total mass of the positive electrode material.

20. The battery according to claim 1, comprising a non-aqueous electrolyte solution, wherein the non-aqueous electrolyte solution comprises an additive; and the additive is selected from at least one of fluoroethylene carbonate, vinylene carbonate, vinyl ethylene carbonate, ethylene sulfate, 1,3-propane sultone or 1,4-butane sultone.
